(19) United States
(12) Patent Application Publication
(10) Pub. No.: US 2013/0035900 A1
(43) Pub. Date: Feb. 7, 2013

(54) Method for Promoting Hygiene and Cleanliness

(71) Applicants: Ricky Wayne Purcell, Alpharetta, GA (US); Jeanne Marie Gatto, Evanston, IL (US); Bruce Williamson, Alpharetta, GA (US)

(72) Inventors: Ricky Wayne Purcell, Alpharetta, GA (US); Jeanne Marie Gatto, Evanston, IL (US); Bruce Williamson, Alpharetta, GA (US)

(21) Appl. No.: 13/195,485

(22) Filed: Aug. 1, 2011

(51) Int. Cl. G06F 17/40; G09B 19/00

(52) U.S. Cl. 702/187; 434/219

(57) ABSTRACT

The present invention provides a method for promoting hygiene in an away-from-home location. The method collects data from an away-from-home location by testing common areas and personal areas within the away-from-home location and takes this data to develop a plan of action to reduce the contaminants within the away-from-home location.

### FIELD OF THE INVENTION

The present invention generally relates to a method for promoting hygiene and cleanliness in an away-from-home location.

### BACKGROUND OF THE INVENTION

It has been recognized in the art that there is a need for promoting good hand hygiene to promote healthier away-from-home locations, such as schools, places of business and the like. It is generally accepted in the art that that poor hand hygiene by one person in an organization of people located at an away-from-home location can adversely affect the other people within the organization. As a result, there have been campaigns and accompanying literature to promote good hand hygiene practices. Examples of such accompanying literature includes the “Ready, Steady, Go!” program guide for the “CLEANYOURHANDS” campaign promoted by the National Patient Safety Agency in the United Kingdom. In addition, U.S. Patent Application Publication 2006/0277065 entitled “Method for Institutionally Effecting Hand Hygiene Practices” has been published. This program and patent are only directed to hand hygiene and do not address other potential sources of contamination or the ways to mitigate those sources of contamination, such as contamination found on surfaces.

Some contaminants such as viruses and bacteria are typically invisible to the human eye. Therefore, it is difficult for a person to know if their hands are contaminated with bacteria, or viruses. A person following the suggestion to wash and/or sanitize hands, stands the risk of having their hand contaminated with contaminates when they touch a surface or an object having contamination. As a result, washing and/or sanitizing hands by itself is not completely effective to prevent the transmission of viruses and bacteria from one person to another.

Contaminants can be transferred from a person's hands to another person's hands or to a surface. Likewise, contaminants can be transferred from a surface to a person's skin, generally a person's hands. Therefore, hand washing and hand hygiene will only stop contamination from a person's hands to another person or a surface. However, hand hygiene will not stop or diminish contamination of a person's hands when a person touches a surface.

There is a need in the art for system or method which will promote hygiene and cleanliness at away-from-home locations that goes beyond the mere washing and sanitizing of hands of people within an organizations. The method needs to cover washing and sanitizing hands as an element, but needs to address other areas of concern, such as surfaces, objects and other potential sources of contamination that may occur at away-from-home locations.

### SUMMARY OF THE INVENTION

Generally stated, the present invention provides a method which is comprehensive and systematic approach to promote hygiene in an away-from-home location.

In one embodiment of the present invention, the present invention provides a method which promotes hygiene in an away-from-home location. The method includes the following steps:
a. conducting an initial evaluation of the away-from-home location using a test protocol to collect initial data and determine an initial level of contamination at various locations within the away-from-home location;
b. evaluating collected data to identify specific needs and/or areas of focus within the away-from-home location;
c. developing a plan of action to address the specific needs and/or areas of focus for the away-from-home location;
d. reevaluating the away-from-home location after a period of time by repeating the test protocol to collect secondary data to determine the second level of contamination within the away-from-home location;
e. evaluating the secondary data as compared to the initial data; and
f. providing feedback to the away-from-home location by conveying a change in the level of contamination at the various locations over the period of time.

In a further embodiment of the present invention, the method may include repeating the evaluation protocols at several different away-from-home locations and compiling the collected data in a database. The data collected may include information regarding what worked and did not work for a given away-from-home location.

The method of the present invention may also involve collecting information from the away-from-home location. Such data collection may include information relating to unplanned absence data from the away-from-home location and compiling the unplanned absence data in a database.

In a further embodiment of the present invention, the feedback provided to the away-from-home location may include unplanned absence data from similarly situated away-from-home locations as compared to the unplanned absence data at a given away-from-home location.

In another aspect of the present invention, the plan of action may include one or more means to motivate employees or users within the away-from-home location to drive compliance with the plan of action. Suitable employee or user motivational means may include posters, e-mails, videos, surveys, feedback/progress cards, contests, prizes for compliance and/or positive outcomes and combination thereof.

In a further embodiment of the present invention, the plan of action will generally include suggesting specific products and methods of using the products to help reduce contamination. Suitable products include at a minimum hand sanitizer, surface cleaners, surface sanitizers, surface disinfectants or facial tissues or combinations thereof. Additional products that may be used in the plan of action include hand soaps, hand cleaners, disposable hand towels, computer keyboard cleaning devices, air disinfecting products, including sprays or air filtration products or a combination thereof. Generally the surface cleaner, surface sanitizer or surface disinfectant may be in the form of a saturated wipe, a spray, a foam, or a liquid. In a further particular embodiment, the surface sanitizer or surface disinfectant may provide surface sanitation or disinfection which lasts for more than 2 hours.

The method of the present invention, in a further embodiment, may also include providing assistance to the away-from-home location with implementing the plan of action for a period of time prior to reevaluating the away-from-home location. Exemplary assistance may include providing employee or user motivational means to engage people within the away-from-home location to drive compliance with the plan of action.

In a further embodiment of the present invention, the method may further providing training at least one person at the away-from-home location, wherein the training includes teaching at least one person to collect the secondary data.

In an additional aspect of the present invention, the test protocol is performed by a person trained in the test protocol. The person conducting the test protocol may be wearing protective gear and the test protocol is performed during normal hours of operation for the away-from-home location.

In a further embodiment of the present invention, the testing may be performed with a cleaning crew normally responsible for cleaning the away-from-home location. Alternatively, the collected data may be shared with the cleaning crew. In a further embodiment involving the cleaning crew, the cleaning crew may be provided with a second plan of action to address specific needs and/or areas of focus.

In a further aspect of the present invention, the following steps are repeated at least one time.
d) reevaluating the away-from-home location after a period of time by repeating the test protocol to collect secondary data to determine the second level of contamination within the away-from-home location;
e) evaluating the secondary data as compared to the initial data; and
f) providing feedback to the away-from-home location by conveying a change in the level of contamination at the various locations over the period of time.

In another embodiment of the present invention, provided is a method for promoting hygiene in an away-from-home location. The method of this embodiment has the steps of:
a. conducting an initial survey of an away-from-home location, the initial survey includes determining a number of people using the away-from-home location on a regular basis, determining the type of away-from-home location, determining the type of working arrangements, and the types of commonly used items;
b. comparing the results of the survey to data stored in a database having similar information to identify areas of focus to promote hygiene within the away-from-home location;
c. developing a plan of action to address the areas of focus for the away-from-home location;
d. implementing the plan of action with the away-from-home location to drive compliance with the plan of action.

In another embodiment of the present invention, provided is a method for promoting hygiene in an away-from-home location. The method of this embodiment has the steps of:
a. conducting an initial survey of an away-from-home location, the initial survey includes determining a number of people using the away-from-home location on a regular basis, determining the type of away-from-home location, determining the type of working arrangements, and the types of commonly used items;
b. comparing the results of the survey to data stored in a database having similar information to identify areas of focus to promote hygiene within the away-from-home location and sharing the compared data with the away-from-home location;
c. developing a plan of action to address the areas of focus for the away-from-home location;
d. implementing the plan of action with the away-from-home location to drive compliance with the plan of action.

By providing the method of the present invention, drawbacks and short coming of conventional hand washing campaigns are avoided and minimized.

### BRIEF DESCRIPTION OF THE DRAWINGS

FIG. 1 shows a block diagram illustrating an embodiment of the present invention.

FIGS. 2A and 2B show a germ map of the present invention.

FIG. 3 shows a block diagram of an alternative embodiment of the present invention.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “away-from-home location” means a place or location where people congregate for various reasons or purposes that are outside the typical home. Examples of away-from-home locations places of business, including, but not limited to, office buildings, office suites, retail stores, warehouses, manufacturing facilities; schools, day care centers; places of worship; hotels and motels; conference centers; and the like.

As used herein, the term “common areas” means areas that are generally accessible by multiply people within the away-from-home location. Examples in an office context are elevators, hallways, break rooms, copy rooms, restrooms, classrooms, lobbies and the like

As used herein, the term “contamination” is intended to mean the presence of viruses, bacteria, mold, allergens and/or other similar substances which may cause humans to become ill.

As used herein, the term “cleaner” means a substance that assist in removing dirt and/or debris from a surface.

As used herein, the term “disinfectant means” a substance that will essentially completely eliminate all the organisms listed on its label. These organisms are not limited to bacteria but could include viruses and fungi. This term generally refers to substances that are regulated by the Environmental Protection Agency.

As used herein, the term “sanitizer” means a substance that will generally kill most of the organisms, generally bacteria. Sanitizers do not have kill or eliminate 100% of the organisms to be effective. This term generally refers to substances that are regulated by the Environmental Protection Agency.

### DETAILED DESCRIPTION OF THE INVENTION

Generally speaking, the present invention relates to a comprehensive and systematic approach to promote hygiene in an away-from-home location. The present invention provides a method with a multi-prong attack on the source of contaminants in an away-from-home location, which results in a cleaner and healthier away-from-home location. By providing cleaner and healthier away-from-home locations the overall chance of contaminants being transferred from one place to another by a person or people within the away from-home, and/or from one person to another, is greatly reduced. It has been discovered that adopting the method of the present invention as a general practice, people within the away-from-home location are less likely to become ill from being at the away-from-home location. As a result, people within the away-from-home location that has adopted the method of the present invention are less likely to take contaminants home to their families from the away-from-home location.

The method of the present invention promotes hygiene in an away-from-home location. The method has several different steps that are used in conjunction with one another to effectively assist the away-from-home location and those people within the away-from-home location to understand and implement a plan of action that promotes improved hygiene. Removing one or more steps or prongs of the method of the present invention can reduce the effectiveness of promoting hygiene at the away-from-home location. To gain a better understanding of the method of the present invention, the method is broken down as a process which includes the following steps:
a. conducting an initial evaluation of the away-from-home location using a test protocol to collect initial data and determine an initial level of contamination at various locations within the away-from-home location;
b. evaluating collected data to identify specific needs and/or areas of focus within the away-from-home location;
c. developing a plan of action to address the specific needs and/or areas of focus for the away-from-home location;
d. reevaluating the away-from-home location after a period of time by repeating the test protocol to collect secondary data to determine the second level of contamination within the away-from-home location;
e. evaluating the secondary data as compared to the initial data; and
f. providing feedback to the away-from-home location by conveying a change in the level of contamination at the various locations over the period of time.

The biggest problem in any away-from-home location is that contaminants, especially bacteria and viruses, are generally invisible to the naked eye. Generally, human senses are typically visually dominated, so items that cannot be seen are generally ignored by people, since they will not receive any visual information from a surface regarding the invisible dangers that may lurk. That is the person will not receive the necessary feedback to understand the danger the may lurk. A surface or an item can look clean to the human eye, meaning free from dirt or grime, but could be laden bacteria and/or viruses, which are invisible to the human eye. This presents a problem for the away-from-home location in that the people using the away-from-home location in that they are unaware of the potential contaminants on the surface. Many times the surfaces must be touched by people within the away-from-home locations to navigate through the away-from-home location or use items at the away-from-home location. Examples of surfaces and items that are commonly touched by people within the away-from-home locations include, door handles, doors, stairway rails, escalator rails, light switches, elevator buttons, office equipment such as copiers keyboards, computers, computer monitors, printers and telephones, vending machines, faucets, beverage dispensers, such as coffee pots, desk top surfaces, conference room tables, chairs, pencils, pens, airplane seatbelts, airplane seatback trays and other similar items commonly found within an away-from-home location.

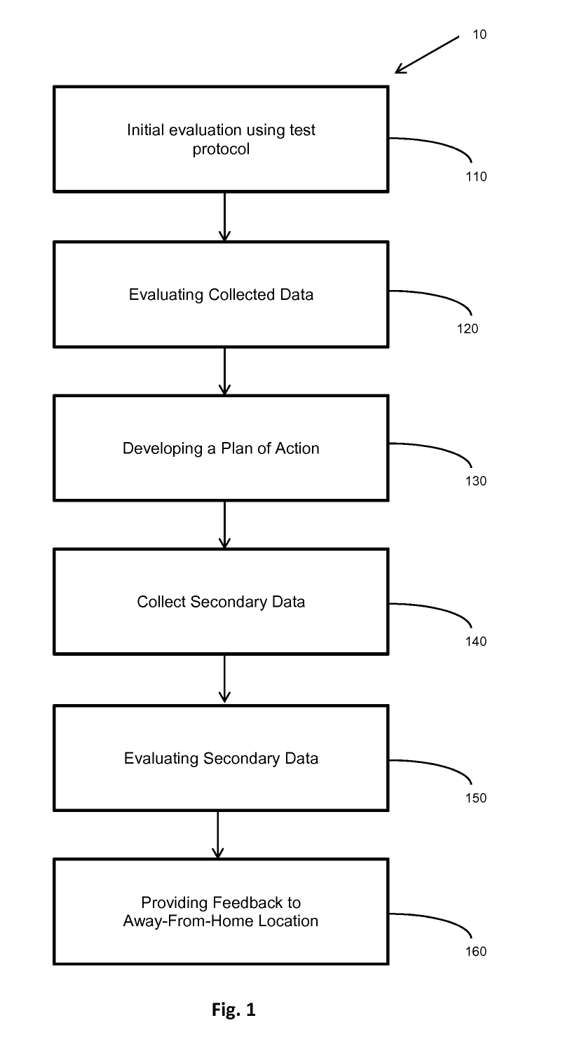

To gain a better understanding of the present invention, attention is directed to the FIG. 1, which shows a flowchart on an exemplary embodiment of the method of the present specification.

As shown in FIG. 1, a method of the present invention 10 has a first step 100, which is a) conducting an initial evaluation of the away-from-home. The initial evaluation will include using a test protocol to determine to collect initial data. Initial data collected can include actual measurements of contamination may be measured through the detection of Adenosine triphosphate (ATP), which is a chemical that is produced by most living organisms. The amount of ATP present on a surface is a widely accepted as a gauge of microbial contamination. Health departments and foodservice inspectors often use ATP readings across North America. ATP readings are so generally relied upon because they offer quantifiable results that can be weighed from one facility to the next, one day to the next. The higher the reading, the higher the presence of organic residue—and that means a greater likelihood of contamination. Because most living things produce ATP, the number generated can be an indication of presence of both harmless and potentially harmful substances. Generally, in non-healthcare and non-food processing environments, ATP readings in the 0-100 range are considered to be safe. ATP readings in the 101-300 range are generally considered to contain a degree of contamination that will need to be disinfected. Readings above 300 are considered to be contaminated and will need disinfecting immediately. ATP readings can be done by commercially available ATP meters, such as those available from HYGIENIA, having offices in Camarillo, Calif. 93012. It is noted that above ranges above are specific to the HYGIENIA ATP meters and there is not industry calibration standard, so meters form different manufactures may have different ranges. It is also noted that the ranges can be adjusted up or down for acceptability, depending on the type of away-from-home location. For example, in a food processing establishment, the upper reading for an acceptable reading could have an upper limit of 50 or less. In some food processing establishments, the upper ATP reading using a HYGIENIA ATP meter could be as low as 30.

The ATP readings are taken at various locations within the away-from-home locations. Generally, the ATP reading will be taken in the both common areas within the away-from-home location as well as semi-private areas, such as offices, cubicles, and restricted areas, such as storage rooms, mechanical rooms and the like. Typically, the ATP testing will be on surfaces such as around the away-from-home location, including desktops, computer keyboards, a computer mouse, telephones, sinks, refrigerator handles, microwave touch pads/screens and handles, counter tops, copier keypads/screens, vending machines, as a potential examples. It is noted that these surfaces are listed an examples, and are is this list is not intended to be exhaustive of the surfaces that may be tested. Generally, the common areas will have ATP readings and a select few or a percentage of the semi-private areas will be tested. For example, 5-25% of the semi-private areas may be tested. It is noted that higher percentages of the semi-private areas may be tested. In fact, all of the common areas and all of the semi-private areas may be tested.

In addition to taking ATP reading, further testing could be done to detect viruses. As of the filing of this application, methods to detect viruses are generally more complicated and typically take longer to process (days vs. minutes for the ATP testing). As new methods to detect viruses which provide readings in a few minutes are developed, the inventors anticipate that these methods can be used in the present invention.

The advantage of taking ATP readings and the like, is these reading provide actual physical evidence (the reading itself) to allow people at the away-from-home location to “see” the presence of contaminants. As stated above, surfaces that appear to be visually clean to a person are often presumed to be contaminate free by that person. It is often hard to get a person to believe that a danger is present, when there appears not to be a danger based on the person's observations. With the evidence of the reading, people within the away-from-home location are provided with the evidence they need to accept that corrective measures are needed to reduce the dangers and unhygienic conditions that may exist at the away from home location.

In addition to determining the presence of bacteria or viruses, the testing protocol could also contain observations of the behaviors of the people within the away-from-home location. These observation could include behaviors before eating, behaviors with respect to hand washing routines after using the restroom, and a behaviors with respect to using shared items within the away-from-home location, such as copiers, printers, coffee stations, vending machines and the like. For example, the observations could be used to determine what percentage of people wash their hands after using the restroom, before eating, or using shared items within the away-from-home location. In addition, the observations may assist in identifying hot spots that may need to be addressed.

The initial data may be collected within a few hours, over a period of day or over a period of week. Data may be collected before cleaning crews clean the away-from-home location and/or after the cleaning crews clean the away-from-home location. Data may be collected at different times during the day, for example, in the morning, at noon or in the evening. The data is generally collected over period of a couple days with the surfaces of the more commonly used items being collected at multiple times. Generally, the average of multiple readings will be used for comparison. However, generally the highest readings, which may possess the highest risk to the people within the away-from-home location may also be reported. To get a true picture of the level of contamination, the initial data will generally be collected over a short period of time, generally of about a few hours to a couple of days to a full week. The initial data will serve as a baseline in which future test will be compared. In addition, the initial data will help identify specific needs and areas of focus in the away-from-home location.

The testing protocol will be can be adjusted for the specific type of away-from-home location. For example, the testing protocol for an office building or office suite may have a major focus on the common areas, the commonly used equipment or surfaces that are commonly touched. Common areas also include areas such as break rooms and conference rooms where people often visit or congregate. Alternatively, focus may be placed on the semiprivate areas, such as offices and cubicles, in the office building or office suite. It has been discovered, that stopping contamination transfer in the semi-private areas actually may reduce the contamination in the common areas, since effectively treating the contamination in the semi-private areas will reduce the ability for the contamination from being transferred back to the common areas. For example, if one person in a semi-private area has contamination and does not effective follow the plan of action of the present invention, which is discussed below, this single person and effectively re contaminate the common areas, allow others in the away-from-home location to carry the contamination back to their semi-private areas. Therefore, identifying the semi-private areas which need to most attention may be more effective at breaking the chain of transmission. Generally, most if not all of the common areas and commonly touched surfaces would be tested and the semiprivate areas would be randomly tested, or could be focus tested. For example, a person who frequents the common areas more often, their semi-private area would be selected for testing. Whereas in a school classroom, attention may be directed to the shared equipment and the desktop surfaces. In any event, the purpose of the initial testing is to get baseline data which future test will be compared.

Generally, the data collected may include the following information:
a. Name of away-from-home location;
b. Type of away-from-home location;
c. Number of people that general located in the away-from-home location on a daily basis;
d. Day, timeframe of testing, day of week, month of the year
e. Temperature, humidity, weather outside;
f. Location within away-from-home location;
g. Item being tested;
h. Location of the surface of the item being tested;
i. Actual time of reading
j. Test reading; and
k. Other addition general information about the away-from-home location such as, flooring surface, types of restroom fixtures (automatic/non-automatic), and type of hand drying devices made available to people with the away-from-home location.

Referring back to FIG. 1, once the initial data is collected, the next step in the process is evaluation of the initial data 120. The initial data is evaluated to identify specific needs and areas of focus within the away-from-home location. Based on the data collected specific types of products and placement of those products will be determined. In addition, the collected data may be compiled in a database for retrieval at a later date for comparison purposes, as will be discussed in more detail below.

In this embodiment of the present invention, the next step 130 is to develop a plan of action for the away-from-home location to implement. The plan of action will generally include a suggestion to use certain products to be used in the away-from home location that can help reduce transferring contaminates from one person to another, from one surface to another, from a person to a surface or from a surface to a person. The products will generally include both hand sanitizers, surface disinfectants and surface sanitizers to assist in diminishing the transfer of contaminants from and to the hands of a user. The plan of action can include other products such as facial tissue, soaps, paper toweling, keyboard cleaners, door handle sanitizers, air filters, air disinfecting sprays, desktop caddies, wall brackets to hold products, centralized hand/surface hygiene stations and other similar products. The plan of action will also provide suggestions for placement of these products which will help facilitate the usage of the products and have the suggested products in a location such that the products are readily available for usage in the identified hot spots.

The hand sanitizers can be in the form of a gel, a foam or a liquid. Generally gels and foams will be dispensed from containers such as bottles that are typically placed on a horizontal surface. Alternatively, the hand sanitizer may be dispensed from a dispenser. Dispensers may be in the form of wall mounted dispensers or dispensers with are free standing floor units or mounted on a free-standing pedestal adapted to hold the dispenser. Hands-free dispensers are very effective in dispensing the hand sanitizer since the user will not have to touch the dispenser. Hand sanitizer will generally be provided in locations where hand sanitizer will be typically needed. Alternatively, hand sanitizers may be provided in the form of a saturated wipe. For example, the hand sanitizer can be located at restroom exits, or outside rest rooms, in or near break rooms where food may be handled, in or near cafeterias or other similar food dispensing areas, in conference rooms, in class rooms and other common areas typically found in away-from-home locations. In addition, each work station in an away-from-home location may be provided with personal sized bottles or dispensers of the hand sanitizer that may be readily accessible at each work station.

Surface cleaners, disinfectants and/or sanitizers may be in the form of a saturated wipe, a spray, a foam, or a liquid. Saturated wipes may be provided in a dispensing canisters, wall units, free standing floor units, or from a free standing pedestal adapted to hold a canister or dispenser of saturated wipes. Generally, the canister or dispenser will be adapted to dispense a single wipe at a time. Alternatively, the surface sanitizer may be in the form of a spray, liquid, or foam. By spray, it is intended that the surface sanitizer is dispensed in a mist of fine fluid droplets. In contrast, liquid is intended to mean a fluid that is not a spray or foam. If the surface sanitizer is provided as a liquid, foam or spray, provide nearby will be a wiper of some sorts, such as a paper towel, so that the user can effectively spread the surface sanitizer on the surface being sanitized. Desirably, but not required, the surface sanitizer should have a long lasting effect such that once the surface is sanitized, the surface sanitizer continues to actively sanitizer the surface for a period of time. An exemplary period of time would be for at least one hour. Longer periods of time, for example 2 hours, 4 hours, 8 hours, or 24 hours, or any period of time in between these exemplary periods of time would be considered advantageous. Of course, the longer last the surface sanitizer the better. Generally, the surface sanitizer will be provided in places in the away-from home location where people within the away-from-home location typically touch or interact with surfaces. Generally, the surface sanitizer will be provided in common areas, such a copy rooms, restrooms, break rooms, conference rooms, classrooms and other similar location. In addition, surface sanitizers may be provided at individual work stations.

Another product that will generally be included in the product bundle is facial tissue. Facial tissue provides a way for a person at an away-from-home location to effectively prevent transmission of contaminants. When a person who has a cold or other similar respiratory ailment, facial tissue is effective in controlling bodily discharges form the eyes, nose and mouth. Any facial tissue is effective; however, facial tissue with antiviral properties such as the KLEENEX Brand Antiviral Facial Tissue, available from Kimberly-Clark Global Sales, LLC may be advantageously used. Facial tissue is generally dispensed from a dispensing carton but may also be dispensed from wall units or from a free standing pedestal adapted to hold a carton of facial tissue. Generally, the facial tissue will be provided in common areas, such a copy rooms, break rooms, conference rooms, classrooms, restrooms, and other similar locations. In addition, facial tissue may be provided at individual work stations.

The suggested products may also contain products with uses in specific locations. Examples of such products include products used in restrooms or break rooms including hand soaps and disposable paper toweling. Providing hand soap to persons within the away-from-home location provides a way for a user to remove dirt and other contaminants from a user's hand. It is noted that hand sanitizers sanitize the hands of the users of the hand sanitizer, but hand sanitizers are generally not useful in removing dirt and other particulate types of contaminants from a user's hands. In addition, paper toweling has been advantageously used to dry and further clean hands of a user. A University of Westminster study, “A Comparative Study of Three Different Hand Drying Methods: Paper Towel, Warm Air Dryers and Jet Air Dryers” by Keith Redway and Shameem Fawdar, November 2008, showed that hand towel are more effect in removing bacteria from a user's hand that forced air dryers. It is a further advantage to have both the hand soap and paper toweling be dispensed from hands-free dispensers so that the user does not have to touch surfaces in a restroom. Hands free dispensers, also known as electronic dispensers, are known in the art. Further providing additional features in the restroom such as hands free commode and water faucet values that automatically dispenser needed water to the fixtures when a user is detected, in the case of the water faucet or when a user leaves a commode or other similar plumbing fixture found in a common restroom.

Another source of surface contamination is keyboards for computers another office equipment. Another product which may be suggested in the products is a keyboard cleaner. The surface sanitizer could be used to sanitize a keyboard, however, the surface sanitizers may have a detrimental effect on the lettering present on the key of the keyboard. Therefore, a milder sanitizer may be desirable. In addition, cleaning keyboards can be difficult to clean between the keys. As a result, a specialty key board cleaner apparatus, such as the one shown in U.S. Pat. D598,667 and/or U.S. Pat. D591,167, which are hereby incorporated by reference.

A further source of contamination is airborne. It is also contemplated that the plan of action may also include products such as air filters which are used to filter the air within the away-from-home location. Any suitable filter material may be used, however, those filter materials that are effective in trapping bacterial are more effective. In addition, disinfecting sprays may be used to assist in reducing airborne contaminants.

As is noted above, the suggested products have specific uses and proposed locations of use. The key to having the products used to promote hygiene within the away-from-home location is having the products easily accessible to those people within the away-from-home location. The products should be provided in plain sight as a reminder to those people within the away-from-home location that the products are available for use. The products should be located very close to the intended place of use. It is contemplated that the other similar products and similar locations not specifically mentioned above within an away-from-home location can be provided with the products, when such products can help promote hygiene within the away-from-home location.

Another aspect of the plan of action, although optional, is to inform to the people with the away-from-home location of the unseen and potential dangers from contaminants within the away-from-home location. Information sharing and awareness of the potential threats can be accomplished allowing people within the away-from-home location to actively observe the data collection of the initial evaluation as well as during the secondary evaluations. As an added effect, testing could be completed by a person wearing protective gear, such as coveralls, a lab coat, a face mask and gloves. Having people within the away-from-home location observe the testing can provide a mental advantage for them to understand the seriousness and dangers contaminants may cause to their well-being. Information can further be provided by sharing the data collected with people within the away-from-home location so that they are aware of the areas of concern or hot spots for contamination within the away-from-home location. Data sharing can be accomplished by any suitable means including verbal interaction with the data collector, visual presentations, e-mails, memos, individual feedback cards, written reports and the like. Along with the information being shared with those within the away-from-home location, education of the dangers contaminants may cause to those within the away-from-home location may also be provided. The information may be provided to all people within the away-from-home location or to select people within the away-from-home location. Preferably the information and education is provided to most, if not all people within the away-from-home location. By providing this information and education, those people within the away-from-home location will become sensitized to the overall hygiene of the away-from-home location and the dangers contaminates may cause to those within the away-from-home location.

The plan of action may also include providing education/training to at least one person at the away-from-home location. The size of the away-from-home location will determine how the training will be implemented and how many people will be trained. Education/training can be provided to all people at the away-from-home location or education could be provided to a select group of individuals that will teach others at the away-from-home location to use the products. For example, in a small office everyone could be trained, as compared to a large corporation were only certain people will be trained and those people will provide education and training to other people within the away-from-home location. Education or training may include on the proper use of the products suggested for use in the plan of action, where and when to use the products, how often to used and how the proper use of the products will promote hygiene in the away-from-home location, by helping reduce contamination. In addition, education may be provided by providing illness outbreak alerts regarding an outbreak or potential outbreak of an illness in the region where the away-from-home location is located, for example influenza outbreaks. Education may be provided through product literature, classroom training, hands on training, web-based training and through outbreak alerts. In addition, training may be provided so that a person at the away-from-home location will be able to take collect data under the test protocol.

Another aspect of the plan of action is to provide employee or user motivational means that will effectively promote usage of the products provided as part of the plan of action. By providing motivational means, the chances of improving the overall percentage of employees or users implementing the plan of action will generally be increased. This way, compliance with the plan of action within the away-from-home location should be higher and the full benefits of the method of the present invention can be realized. Examples of suitable motivational means include, for example, e-mails, videos, surveys, contest, prizes for compliance and/or employee or user engagement and combination thereof. Generally, the purpose of the employee or user engagement means is drive compliance with the plan of action. Motivation means may be matched to the away-from-home location's authority and/or risk level. For example, an office environment will generally have a lower risk than does a hospital or a doctor's office. Generally, away-from-home locations that have higher risk include health care facilities, food processing facilities and the like. Further, an office will have less authority to enforce hygiene compliance than other facilities such as food processing facilities, which are highly regulated. As part of the plan of action of the present invention, the motivational means may be tailored to the needs of the particular away-from-home location.

Suitable e-mails and videos may include information regarding how to use products, the benefits of the products, results from the test protocol, improvements obtained in the hygiene at the away-from-home location, percentage of the employees or users currently using the products, regional illness outbreak information or a combination thereof. Typically, an e-mail or video can come from anyone in the away-from-home location, but is generally better if the e-mail or video comes from a person of authority, such as the CEO or president of the company. Alternatively, the e-mail or video may come from a designated person within the away-from-home location who is in charge of implementing the plan of action. If the away-from-home location is large enough to cover several different areas within a floor of a building, has employees or users that are located on different floors or different buildings, the e-mails or videos could report results of the testing protocols or subsequent test and compare the different areas to one another. As a result, compliance with the plan of action will generally be improved in those areas with the poorest results as a sense of personal pride may come into play. Likewise in the areas of having the best results will continue to strive to be the leader, thereby maintaining compliance with the plan of action in those areas as well.

Employee or user surveys on usage of the specific products may also be used to engage employees or users actual compliance with the plan of action. Surveys could be used as a way for employees or users within the away-from-home location to provide feedback on the plan of action and ways for the employees or users to suggest improvements or changes to the plan of action to improve employee or user motivation to implement the plan of action. The survey could ask the user for additional types of products that the user would like to be provided to further improve the hygiene at the away-from-home location. Surveys allow employees and users to feel like they have a say in the implementation of the plan of action and that they are part of the plan of action. The survey will also allow the away-from-home location to gauge the degree of employee or user compliance with the plan of action.

One very effective way to promote employee or user engagement is to have contest between different areas within the away-from-home location. Winners of the contest could be provided with prizes or just recognition as being the area with the best hygiene. With prizes being awarded, there is additional incentive to comply with the plan of action. Different areas could be different work groups within the away-from-home location or could be different floors or different buildings of the away-from-home location. Different areas when it comes to schools or classrooms could be each classroom or each grade within the school. Smaller groups could be joined together to create an area. Prizes could be awarded for area compliance or positive outcomes judged by the percentage of surveys returned, including, the area which is judged to be the cleanest, the area which has the greatest percentage of employees or users complying with the plan of action, the area which has the largest improvement in hygiene based on the test protocol results, or the area which has the largest improvement with employees or user complying with the plan of action or a combination thereof. These prize categories are intended to be exemplary and not limiting. Generally, by providing prizes, the employees or users within the area will be incentivized to implement and comply with the plan of actions. It is contemplated prizes could be awarded to the area on a group basis or could be awarded to an individual in the area. If a prize is only awarded to an individual within the area, all individuals within the area will generally be eligible to win the prize. Generally, since the goal is to drive compliance with the plan of action, prizes will be typically award to the winning area within the away-from-home location. When it comes to surveys, all participants completing and turning in the survey could be eligible to win a personal prize while the area would be eligible to win a group prizes. Examples of prizes that could be awarded to an area within the away-from-home location, a free meal, a group activity or some other similar benefit to the group. Prizes awarded to individuals will be more on an individual/personal basis, for example a gift card or gift certificate.

Implementing the plan of action may be the sole responsibility of the away-from-home location. Alternatively, the implementation of the plan of action may be solely the responsibility of the developer of the plan of action or the provider of the products used in the plan of action. In another embodiment of the present invention, the implementation of the plan of action is done is such a way that at the beginning of the implementation of the plan of action, the developer of the plan of action is actively involved for the first few weeks or months and the responsibility of continuing the plan of action is eventually turned over to the away-from-home location. However, the developer of the plan of action may stay actively involved with the away-from-home location on a periodic basis to assist the away-from-home location in continuing to use the plan of action so that the away-from-home location does not resort to its previous action prior to the implementation of the plan of action. Once the plan of action is implemented by the away-from-home location, typically, the developer of the plan of action will provide full assistance service to the away from home location for a period of time, generally 30, 60 or 90 days. After this period of time, the developer of the plan of action will generally be available for consultation purposes.

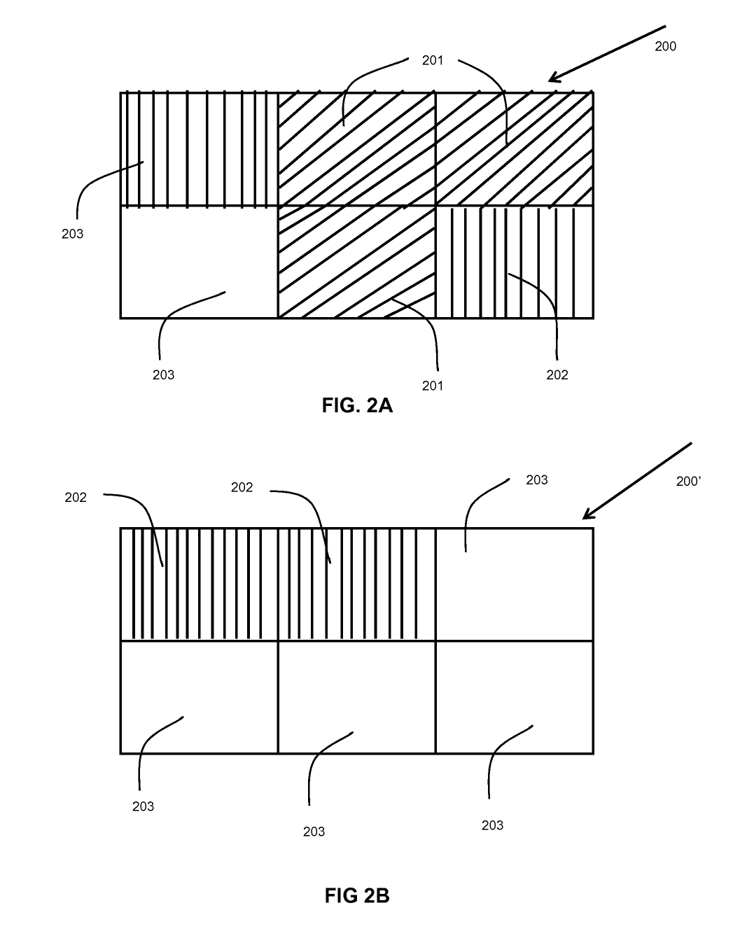

Once the plan of action is implemented by the away-from-home location, after a period of time the away-from-home location is reevaluated from a contaminant standpoint as the next step in the method of the present invention. To reevaluate the away-from-home location, the test protocol is repeated to collect a secondary data 140, as is shown in FIG. 1. This secondary data is evaluated 150 as the next step of the process to determine a second level of contamination within the away-from-home location. Once collected, the secondary data is compared to the initial data to determine if the plan of action is effective in reducing contamination at the away-from-home location. It is important that the exact same test protocol is repeated and the data is again collected and evaluated. Optionally, the secondary data collected could collected in all of the same locations as the initial data was collected or the number of test locations could be reduced to a statistically significant sampling to improve efficiency. Based on the comparison of the secondary data to the initial data, the next step in the method of the present invention is to provide feedback is provided to the away-from-home location 160. The feedback will include the comparison of the secondary data to the initial data. This feedback may include areas where the plan of action is effective and areas where the plan of action is not as effective or was ineffective. The results may be shown as graphically as areas of the building or floor of the building as a germ map, as is shown in FIGS. 2A and 2B. FIG. 2A is a representation of a germ map 200 the level of contamination as based on the initial testing where areas labeled 201 are areas of high contamination, areas labeled 202 are areas of moderate contamination and areas labeled 203 are areas with low contamination. FIG. 2B is a representation of a germ map 200′ that shows the level of contamination based on the secondary testing. Again areas labeled 201 are areas of high contamination, areas labeled 202 are areas of moderate contamination and areas labeled 203 are areas with low contamination. The germ map can demonstrate to the away-from-home location the changes in the contamination based on using the method of the present invention. As shown in FIGS. 2A and 2B different sections of a floor of a building are shown. It is noted that the germ maps could be used to show semi-private areas, or common areas on a individualized basis. It could also show where in the away-from-home the method plan of action is being followed and where the plan of action may not being followed. Germ maps, such as the ones shown in FIGS. 2A and 2B may be shown over time for each set of secondary data collected to track progress in improving the hygiene in the away-from-home location. As result, the feedback may include areas of focus for the away-from-home location to obtain an overall improvement in the level of contamination.

If areas within the away-from-home location have not improved with respect to contamination, the plan of action may need to be reevaluated for its effectiveness. Also, if the secondary data does not indicate an improvement in contamination, it may suggest that the plan of action is not being followed by the away-from-home location and further assistance or further education may need to be provided to the away-from-home location, which would be included in the feedback.

In addition, to collecting the secondary data, surveys or usage rates of the products suggested in the plan of action may also be evaluated. Low product usage and/or little to no improvement in the level of contamination may indicate low user participation in the plan of action. In this case, further education or other motivational means might need to be provided people within the away-from-home location to improve the overall hygiene in the away-from-home location. It may be necessary to change the motivational means currently being used in the away-from-home location to others described above.

As a further aspect of the present invention, additional sets of data may be collected on a regular basis and compared to the prior set of data or all of the previously collected data. Additional evaluation using the test protocol is an effective way to prevent the away-from-home location from slipping back into the ways prior to implementing the plan of action. Future testing should be conducted on a regular basis and may be extensive as the initial testing, reduced to a statistically significant sampling or limited to those spots indicated by either the initial testing or the secondary data collection as being hot spots.

The main purpose of the plan of action is to drive behavior change among those at the away-from-home location in a manner so as to improve hygiene in the away-from-home location and to potentially reduce the potential spread of illness within the away-from-home location. By providing incentives and engaging the employees or users of the away-from-home location, behavior change is driven in a positive manner. Effective motivation of the employees or users at the away-from-home location will tend to close the gap between those who embrace the plan of action and those that do not. One example of an effective motivational means is providing positive reinforcement to those who have engaged the plan of action therein providing incentive for those who have not engaged the plan of action to do so. The inventors of the present invention have seen demonstrated positive results with respect to unplanned absences in away-from-home locations in controlled studies as will be discussed below. As a result, the method of the present invention provides benefits not only to those people present at the away-from-home location, but also to the employer, in the case of an away-from-home location which is a business. In the case of places of learning, such as schools, there may be a reduction of absenteeism among students, since the students may have less of a chance of being exposed to contaminants while at the away-from-home location.

As was discussed above, the data collected for each location may be stored in a database. Repeating the collection process for several different locations may result in a database that can be quickly accessed and information retrieved for the purposes of recommending a plan of action. All of the information including described above will be stored. In addition, the secondary data will also be stored. The database will also track the plan of action, including any employee or user engagement means. The purpose of storing data is to later track similarly situated away-from-home locations that have similar number of employees or users and similar facilities. By using a database of the data collected from initial testing and secondary testing, the database can be used in a further process of the present invention.

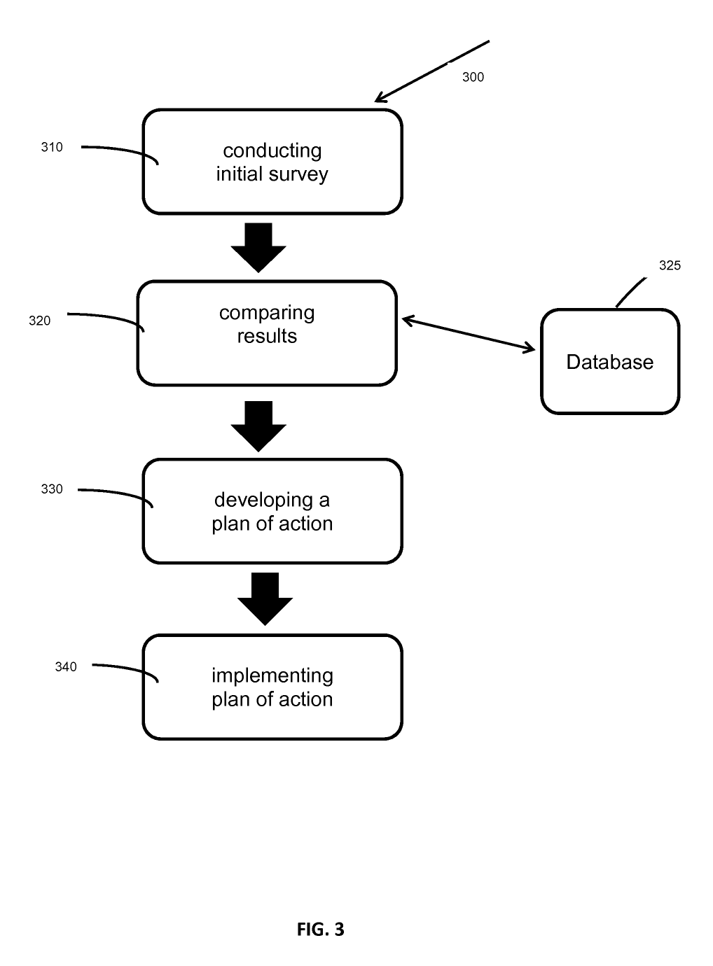

In this embodiment of the present invention. In another embodiment of the present invention, provided is a method for promoting hygiene in an away-from-home location. To gain a better understanding of the method, attention is directed to FIG. 3. The method 300 of this embodiment has the steps of:
a. conducting an initial survey of an away-from-home location 310;
b. comparing the results of the survey to data 320 stored in a database 325.
c. developing a plan of action 330 to address the areas of focus for the away-from-home location based on a prior plan of action stored in the database;
d. implementing the plan of action 340 with the away-from-home location to drive compliance with the plan of action.

The initial survey may be similar to the initial survey in the other aspect of the present invention. However, the initial survey in this aspect of the invention can be limited to determining a number of people using the away-from-home location on a regular basis, determining the type of away-from-home location, determining the type of working arrangements, and the types of commonly used items having similar information to identify areas of focus to promote hygiene within the away-from-home location. This information is used to compare to the data stored in the database to determine if a similar situated away-from-home location has already been tested. This aspect of the present invention may be used to avoid the cost of conducting a full initial survey as is done in the first aspect of the present invention. Based on the results obtained, the information from the database can be used to recommend a plan of action based on what was effective for similarly situated away-from-home locations. The database may be used to track the types of plan of action that was successful for a given away-from-home location which is similar to a new away-from-home location attempting to adopt the method of the present invention. In addition the database may be used to keep track of which types of plan of actions that were not successful in similarly situated away-from-home locations, so that the plan of action will generally be successful on the first attempt. The database may also be used to quickly identify the hot spots within the away-from-home location that could be quickly addressed for a quick win at providing hygiene at the away-from-home location. This aspect of the present invention is more cost effective, but the plan of action is based on a similar situated away-from-home locations. As a result, the plan of action is a semi-custom plan of action based on prior plans of action.

Several test pilots were performed in different office building, including law firms, customer service facilities, and corporate offices and places of manufacture of intermediate products during the cold and flu season during the winter of spanning November 1 through April 30. In each of these locations, initial testing was conducted to identify the hot spots and areas of concern. Hot spots and areas of concern included door handles, food prep areas in breakrooms, copiers and keyboards. The following products were provided to each location: alcohol hand sanitizer, wet antimicrobial wipes, tissues and educational materials were provided. After the initial testing, instruction on how to use the products provided in addition to the educational materials. Weekly ATP (Adenosine Triphosphate) testing was conducted and the results were collected and tabulated. Individuals at each location were asked to take survey and provide feedback regarding each of the products. In addition, weekly survey regarding attitudes, product usage and illness reduction were taken. The results of the test pilots showed that week over week, there was a steady decline of ATP on surfaces tested. The pilot studies showed that 95.4% of pilot location employees actively participated (i.e. used the products, did the challenge, completed some or all surveys). 77.8% of the participants surveyed believe the products and educational material provided help improve their well-being when it comes to illness acquired on the job. 91.2% of pilot participants wanted the pilot to continue at their workplace at the end of the pilot.

In one pilot program, the corporate offices were spread among two building. One building was used in the pilot and the other was used as the control. Unplanned absences were tracked at teach office building and the results are reported in Example 1.

### EXAMPLE 1

A study was completed in place of business that was located in two separate office buildings in an office complex. The first building was provided with a product bundle including alcohol based hand sanitizer, wet disinfecting surface wipes, Kleenex Brand tissue that were strategically place within one of the office buildings. The occupants within the first building were educated on the use of each of these products and how these products can improve the hygiene of the offices within the building. The second office building was not provided with the products or educational on how to use the products. Unplanned absences were recorded over a 17 week period. It is noted that the unplanned absences were only unplanned absences where the employee was out of the office due to leave that was not planned in advance. It is noted that this may have included absences that were unrelated to illness. However, it is assumed that the unplanned absence other than illness would be about the same for each building over a given period of time. Over the 17 week period, the pilot office building reported an unplanned absence rate average of 2.0% while the control building reported an unplanned absence rate average of 3.2%. The results for each office building are shown in Table 1. These results tend to show that providing products and education materials on how to use these products can potentially reduce the unplanned absenteeism rate.

TABLE 1
ABSENTEEISM RATE

| WEEK | BUILDING 1 | BUILDING 2 (CONTROL) |
|---|---|---|
| 1 | 2.6% | 2.6% |
| 2 | 1.8% | 2.6% |
| 3 | 1.8% | 2.2% |
| 4 | 0.8% | 0.4% |
| 5 | 2.8% | 4.4% |
| 6 | 2.4% | 4.8% |
| 7 | 2.2% | 0.9% |
| 8 | 0.6% | 0.4% |
| 9 | 1.0% | 1.3% |
| 10 | 3.0% | 3.9% |
| 11 | 2.2% | 3.1% |
| 12 | 2.0% | 4.8% |
| 13 | 2.6% | 4.8% |
| 14 | 1.8% | 4.4% |
| 15 | 2.4% | 3.9% |
| 16 | 1.8% | 5.7% |
| 17 | 1.2% | 3.9% |

### EXAMPLE 2

The inventors of the present invention worked with Dr. Gerba of University of Arizona to complete a study on the effectiveness of using a combination of hand sanitizer, surface disinfecting wipes, and facial tissues in reducing contamination in an office environment. It was shown that the providing the hand sanitizer, surface disinfecting wipes and facial tissue reduced the active sites of seeded viruses in the office setting. In the test procedure, viruses were placed on door handle in the Office. Testing was conducted and with and without the use of the hand sanitizer, surface disinfecting wipes and facial tissue. ATP measurements were taken at 4 and 8 hours after seeding and the results are shown in Table 2.

TABLE 2
Percentage of sites on which MS-2 was detected in
the office before and after the plan of action

| Time after release of | % sites positive for virus | % sites positive |
|---|---|---|
| virus | before intervention | after plan of action |
| 4 hours | 24 | 6 |
| 8 hours | 25 | 10 |
| 4 and 8 hours combined | 24 | 9 |

As can be seen in Table 2, a plan of action which includes hand sanitizer, surface disinfecting wipes and facial tissue effectively reduced the presence of the virus with the away-from-home location.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A method for promoting a hygiene in an away-from-home location, said method comprising
a. conducting an initial evaluation of the away-from-home location using a test protocol to collect initial data and determine an initial level of contamination at various locations within the away-from-home location;
b. evaluating collected data to identify specific needs and/or areas of focus within the away-from-home location;
c. developing a plan of action to address the specific needs and/or areas of focus for the away-from-home location;
d. reevaluating the away-from-home location after a period of time by repeating the test protocol to collect secondary data to determine the second level of contamination within the away-from-home location;
e. evaluating the secondary data as compared to the initial data; and
f. providing feedback to the away-from-home location by conveying a change in the level of contamination at the various locations over the period of time.

2. The method according to claim 1, further comprising repeating the method at several different away-from-home locations and compiling the collected data in a database.

3. The method according to claim 1, further comprising collecting unplanned absence data from the away-from-home location and compiling the unplanned absence data in a database.

4. The method according to claim 3, further comprising repeating the method at several different away-from-home locations and compiling the collected data in a database.

5. The method according to claim 4, wherein the feedback further comprises information relating to unplanned absence data for the away-from-home location compared to unplanned absence data from the database.

6. The method according to claim 1, further comprising providing motivational means to engage people within the away-from-home location to drive compliance with the plan of action

7. The method according to claim 6, wherein the motivational means comprises e-mails, videos, surveys, contest, prizes for compliance and/or engagement and combination thereof.

8. The method according to claim 6, further comprising completing surveys on usage of specific products suggested to execute the plan of action.

9. The method according to claim 7, wherein the feedback further comprises information relating to unplanned absence data for the place of business as compared to unplanned absence data from the database.

10. The method according to claim 1, developing a plan of action comprises suggesting products and method of using the products to help reduce contamination.

11. The method according to claim 10, wherein the specific products comprise hand sanitizer, surface cleaners, surface disinfectants, surface sanitizers, and facial tissues.

12. The method according to claim 11, wherein the specific products further comprises hand soaps and disposable hand towels.

13. The method according to claim 11, wherein the specific products further comprise a computer keyboard cleaning device.

14. The method according to claim 11, wherein the surface cleaner, surface disinfectant or the surface sanitizer comprises a saturated wipe, a spray, a foam, or a liquid.

15. The method according to claim 11, wherein the surface sanitizer or surface disinfectant provides surface sanitation which last for more than 2 hours.

16. The method according to claim 11, wherein specific products further comprises air filtration or air disinfection.

17. The method according to claim 10, further comprising providing training at least one person at the away-from-home location on the proper use of the products.

18. The method according to claim 1, further comprising assisting the away-from-home location with implementing the plan of action for a period of time prior to reevaluating the away-from-home location.

19. The method according to claim 18, wherein the assisting comprises providing motivational means to engage people within the away-from-home location to drive compliance with the plan of action

20. The method according to claim 19, wherein the motivational means comprises e-mails, videos, surveys, contest, prizes for compliance and/or engagement and combination thereof.

21. The method according to claim 1, wherein the contamination comprises a virus bacteria, mold, and/or allergen.

22. The method according to claim 21, wherein the contamination comprises at least one virus and/or at least one bacterium.

23. The method according to claim 1, further comprising providing training at least one person at the away-from-home location, wherein the training includes teaching at least one person to collect the secondary data.

24. The method according to claim 1, wherein the test protocol is performed by a person trained in the test protocol.

25. The method according to claim 24, wherein person performs the test protocol wearing protective gear.

26. The method according to claim 25, wherein the testing protocols are performed during normal business hours.

27. The method according to claim 1, wherein the test protocol is performed with a cleaning crew normally responsible for cleaning the away-from-home location.

28. The method according to claim 27, wherein the collected data is shared with the cleaning crew.

29. The method according to claim 28, wherein the cleaning crew is provided with a second plan of action to address specific needs and/or areas of focus.

30. The method according to claim 1, further comprising repeating steps d, e and f of claim 1.

31. The method according to claim 1, wherein the away-from-home location is an office building, an office suite, a retail stores, a warehouse, a manufacturing facility; a school, a day care center; a place of worship; a hotels, a motel, or a conference centers.

32. A method for promoting hygiene in an away-from-home location, said method comprising
a. conducting an initial survey of an away-from-home location, the initial survey includes determining a number of people using the away-from-home location on a regular basis, determining the type of away-from-home location, determining the type of working arrangements, and the types of commonly used items;
b. comparing the results of the survey to data stored in a database having similar information to identify areas of focus to promote hygiene within the away-from-home location;
c. developing a plan of action to address the areas of focus for the away-from-home location;
d. implementing the plan of action with the away-from-home location to drive compliance with the plan of action.

33. The method according to claim 32, further comprising sharing the database information with the away-from-home location.
